(19) United States
(12) Patent Application Publication
(10) Pub. No.: US 2023/0283580 A1
(43) Pub. Date: Sep. 7, 2023

(54) STORY MESSAGE GENERATION

(71) Applicant: Microsoft Technology Licensing, LLC, Redmond, WA (US)

(72) Inventors: Victoria RODRIGUEZ, Lynnwood, WA (US); Joseph FLINT, Redmond, WA (US); Vanessa Samantha LANN, Bothell, WA (US); Daniel LECLAIR, Kenmore, WA (US)

(21) Appl. No.: 17/686,275

(22) Filed: Mar. 3, 2022

(51) Int. Cl. H04L 51/10; H04L 51/046; H04L 51/08; H04L 51/00

(52) U.S. Cl. CPC H04L 51/10; H04L 51/046; H04L 51/08; H04L 51/16; H04L 51/14

(57) ABSTRACT

Social media posts and other generated story messages may include a hero image and other story elements, such as text, links, coupons, countdowns, or gift cards. Hero image selection mechanisms and story element obtention mechanisms are described. Criteria sets, scoring factors, and suitability scoring mechanisms are provided for testing the suitability of emails as sources of content for automatically generating social media posts and other story messages. Example user interface organization mechanisms and layouts are described. The various mechanisms permit fully or largely automatic testing of candidate emails, candidate images, and candidate texts which filters out unsuitable content and thereby avoids overburdening a human reviewer with false positive attempts at generated messages.

### BACKGROUND

Some social media networks allow a user to upload photographs with accompanying text, long videos, short videos, and other audiovisual content. Uploaded content is then made available through the social network to followers of the user, or in some cases to the public at large. Sometimes a viewer of the content can modify a local copy of the content, e.g., by applying a computational filter or lens. Music videos, dance videos, vlog (video log) clips, and many other kinds of entertainment, educational, promotional, inspirational, interactive, or newsworthy content are often uploaded. A given piece of content is not necessarily limited to a single category.

Some social media networks have apps (application programs) that permit a user to create or edit audiovisual content prior to uploading the content. Apps may be available on mobile devices, on websites, or on both. In many cases, users can also create content by using more powerful video editing tools, photo editing tools, image creation tools, or graphic design tools outside the app, and then import the created content into the app for uploading.

However, advances are still possible in the technology for creating social media content. Advances may provide or enhance previously available benefits of various approaches to content creation.

### SUMMARY

Some embodiments described herein generate a message in a social media visual style defined by specified characteristics. The generated message may be presented in an email inbox, or posted to social media networks, for example. Message generation may include automatically selecting a suitable email, web page, or other message source, based on specific technical criteria. Some embodiments automatically select a hero image from an email, a web page, or another source, based on specific technical criteria. Some embodiments generate image-focused content, such as a message whose most prominent aspect is a color photograph or a very short (under ninety seconds) video clip. Some embodiments automatically select a textual or other story element from an email, a web page, or another source, based on specific technical criteria. Some embodiments aid the automatic separation of incoming email into categories that include unwanted solicitations, personal or recipient-specific correspondence, and permitted commercial promotional offerings.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems and also illustrating configured storage media;

FIG. 2 is a block diagram illustrating aspects of a computing system which has one or more of the message generation facilitation enhancements taught herein;

FIG. 3 is a block diagram illustrating an enhanced system configured with story message generation facilitation functionality;

FIG. 4 is a block diagram illustrating aspects of some emails and other message sources;

FIG. 5 is a block diagram illustrating aspects of some mechanisms which may be utilized in connection with message generation facilitation;

FIG. 6 is a block diagram illustrating aspects of some suitability scoring mechanisms;

FIG. 7 is a block diagram illustrating some aspects of suitability testing during message generation facilitation;

FIG. 8 is a block diagram illustrating aspects of some generated story messages;

FIG. 9 is a diagram illustrating a hierarchical organization of story messages;

FIG. 10 is a block diagram illustrating some aspects of hero image suitability testing during message generation;

FIG. 11 is a stylized user interface of a mobile device illustrating a hierarchical organization of some generated hero story messages;

FIG. 12 is a stylized user interface of a mobile device illustrating a generated hero story message;

FIG. 13 is a flowchart illustrating steps in some message generation facilitation methods; and

FIG. 14 is a flowchart further illustrating steps in some message generation facilitation methods, incorporating FIG. 13.

### DETAILED DESCRIPTION

Overview

Innovations may expand beyond their origins, but understanding an innovation's origins can help one more fully appreciate the innovation. In the present case, some teachings described herein were motivated by technical challenges arising from goals based on ideas about social media, about how brands communicate on social media, and about generational approaches to social media. In particular, Microsoft innovators explored ways that members of Generation Z use social media. Generation Z is a loosely defined demographic cohort which includes people born from the mid-1990s to the early 2010s, e.g., during 1996 to 2013. A goal was to find opportunities for Microsoft to facilitate and use forms of communication that are compatible with Generation Z uses of social media. The innovators determined that such opportunities could involve presenting generated messages in an email inbox, either with other messages or as a separate stream, and could also include posting generated messages on social media platforms.

Microsoft innovators determined that in addition to promotional emails, or in place of them, some brands promote their products and services on popular social media which emphasize video and photographic content formatted for mobile devices. Some examples include the INSTAGRAM® (mark of Instagram, LLC), TIKTOK® (mark of Bytedance, Ltd.), and SNAPCHAT® (mark of SNAP, Inc.) platforms. These are merely examples; one of skill may also beneficially apply the teachings herein to generate story messages for posting on other social media platforms, and for displaying in other contexts such as an email inbox.

These social media promotions are sometimes called “stories” in order to emphasize a goal of engaging recipients in an ongoing active manner. The innovators concluded that instead of presenting bare facts or lots of text, these promotional stories attempt to capture a recipient's attention using an entertaining video clip or photograph. When a video is used, it is generally short (under three minutes). When a photograph is used, it is often a color photograph of a promoted product, or of someone using a promoted service. The story is often formatted as a message whose entire content, or at least the most important part of its content, can be fully displayed on a single screen of a mobile device so that the recipient can see most or all of the message without scrolling.

The content invites (or urges) the recipient to participate in the story, e.g., by interacting with the post, and in particular by purchasing the promoted product or service. The post may contain purchase incentives such as discounts or coupon codes. The post may urge action through a countdown indicating when a sale ends, or one showing how many products or service slots remain available for purchase. Often the post includes a hyperlink to an online storefront.

The innovators asked themselves whether it might be possible to generate INSTAGRAM® posts or similar story messages from existing materials, instead of creating them with only a video clip or a photograph as a starting point. In particular, the innovators investigated the possibility of automatically generating such a story message from an existing promotional email. An automatic approach to story message generation that worked effectively could provide various benefits. Message generation could automatically utilize existing data to populate a new visually compelling content stream, in ways that are not feasible without automation. Automatic message generation could also be much more efficient than creating posts largely by hand, e.g., as when a person selects an image and then writes text copy to incorporate the image in a story message. Automatic image selection could sift through potential hero images much more quickly than a person. But care would be needed to make the image selection effective, e.g., simply selecting the top image from an email might get a banner or a tracking pixel or a navigation button image that would repel a recipient or be ignored by them if posted or displayed, instead of inviting them into the story.

The innovators' investigation gave rise to several technical challenges. An initial challenge was how to objectively distinguish between the look and feel of a promotional email and the look and feel of a promotional posting like the ones that target Generation Z recipients on platforms such as INSTAGRAM®, TIKTOK®, and SNAPCHAT® (marks of their respective owners as noted above). Embodiments disclosed herein address this challenge by identifying criteria for computationally choosing content from an email to be placed in a story message. The criteria focus on selection of a hero image and supporting story elements. In effect, these criteria define a story message format and content style, by excluding material that does not fit the embodiment's story message criteria.

The innovators realized that not all promotional emails were suitable sources of content that meets story message criteria. This presented the technical challenge of determining automatically and efficiently whether or not a given email is a suitable source for generating a story message. Embodiments here address this challenge by specifying computationally ascertainable criteria for email suitability.

Other technical challenges encountered were how to automatically determine whether or not a given image is suitable for use in a story message, and how to automatically choose email text or related text elements to support the hero image in the story message. Embodiments address these challenges by specifying computationally ascertainable criteria for hero image suitability and story element suitability.

Many of the embodiments may be described as facilitating message generation, because their functionalities for assessing source email suitability, hero image suitability, and text element suitability are useful even when no message is ultimately generated from a particular email or other message. It is useful to know which messages, which images, and which texts are not suitable for inclusion in a story message, and why, even when a lack of suitable content means no story message is generated.

For example, sometimes an email is an unsuitable source because it is personal and specific to the recipient, e.g., an email notice that the rent deadline is being changed to the 10^{th} of the month is unlikely to promote any widespread purchasing. Sometimes an email is unsuitable as a story message source because it is unsolicited commercial email (colloquially known as “spam” email). Posting or displaying such email could lead to reputation damage because of the social stigma attached to it, as well as the cybersecurity risk of propagating malware.

As another example, an image might not be suitable for use as a story message hero image because it is a slice of a larger image. Reconstituting the larger image may produce a suitable hero image (perhaps with resizing), but a failure to recognize that an image is a slice could lead to reputation damage from posting or displaying an image that looks like a mistake. Story messages work best when they give a sense of having been crafted carefully.

More generally, the present disclosure provides technical mechanisms to address these and other technical challenges, in the form of various story message generation facilitation functionalities. These functionalities may be used in various combinations with one another, or alone, in a given embodiment.

Operating Environments

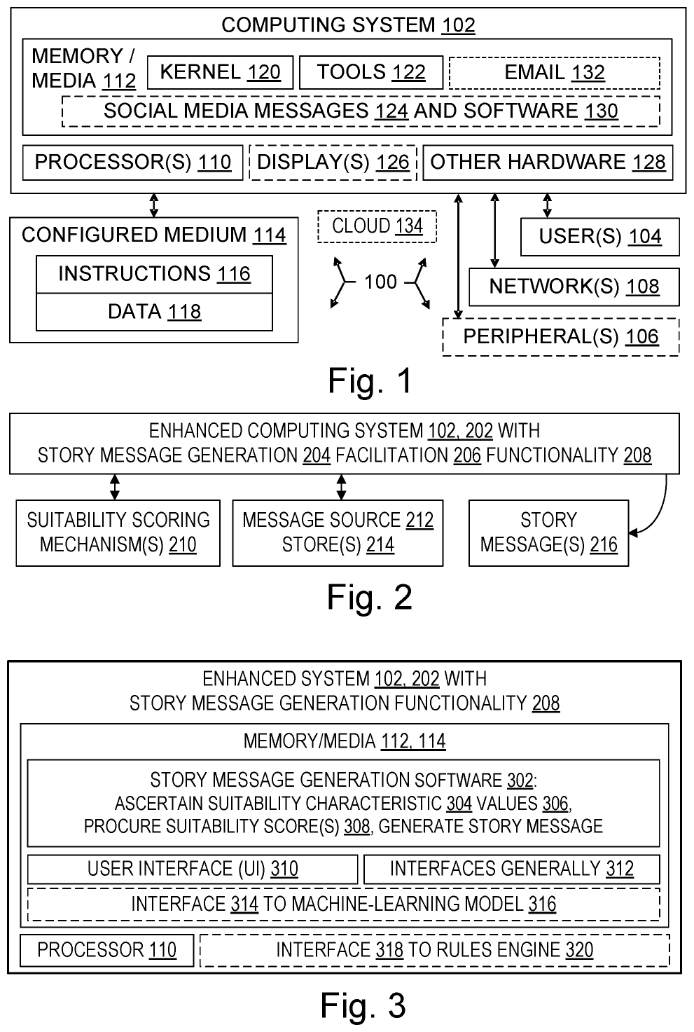

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 134. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. Virtual reality or augmented reality or both functionalities may be provided by a system 102. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, graphic designers, copywriters, creative directors, production assistants, developers, testers, engineers, auditors, and end-users are each a particular type of human user 104. Automated agents, scripts, playback software, devices, and the like running or otherwise serving on behalf of one or more humans may also have accounts, e.g., service accounts. Sometimes an account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a cloud 134 and/or other network 108 via network interface equipment, for example.

Each computer system 102 includes at least one processor 110. The computer system 102, like other suitable systems, also includes one or more computer-readable storage media 112, also referred to as computer-readable storage devices 112. Email 132, and posts 124, direct messages 124, and other social media messages 124, may reside in media 112 within a system 102. Social media software 130 may include apps 122 on mobile devices 102 or workstations 102 or servers 102, as well as APIs, browsers, web storefronts, and other webpages and the corresponding software for protocols such as HTTPS.

Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs, GPUs, and/or quantum processors), memory/storage media 112, peripherals 106, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, story message generation facilitation functionality could be installed on an air gapped network and then be updated periodically or on occasion using removable media 114. A given embodiment may also communicate technical data and/or technical instructions through direct memory access, removable or non-removable volatile or nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More about Systems

FIG. 2 illustrates a computing system 102 configured by one or more of the message generation facilitation enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 illustrates an enhanced system 202 which is configured with story message generation facilitation software 302 to provide story message generation facilitation functionality 208. FIG. 3 items are discussed at various points herein, and additional details regarding them are provided in the discussion of a List of Reference Numerals later in this disclosure document.

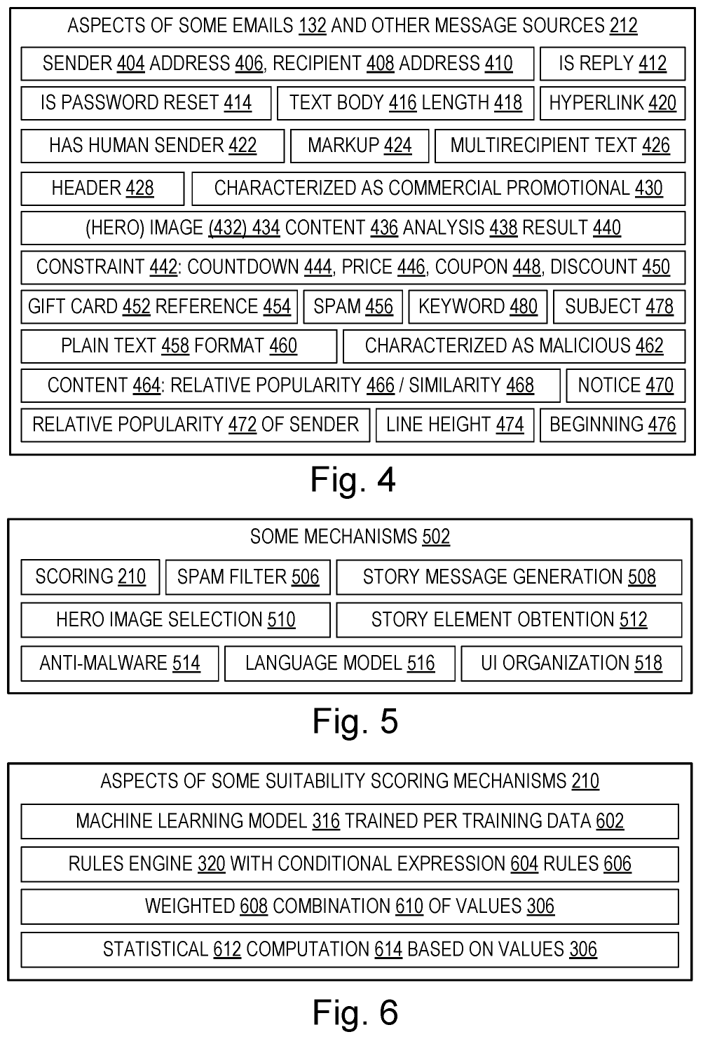

FIG. 4 shows some aspects of emails 132 and other message sources 212. This is not a comprehensive summary of all sources 212 which may include candidate material for potential use in message generation. FIG. 4 items are discussed at various points herein, and additional details regarding them are provided in the discussion of a List of Reference Numerals later in this disclosure document.

FIG. 5 shows some mechanisms 502. This is not a comprehensive summary of all mechanisms 502 which may be useful in message generation. FIG. 5 items are discussed at various points herein, and additional details regarding them are provided in the discussion of a List of Reference Numerals later in this disclosure document.

FIG. 6 shows aspects of some suitability scoring mechanisms 210, 502. This is not a comprehensive summary of all suitability scoring mechanisms 210 which may be useful in message generation. FIG. 6 items are discussed at various points herein, and additional details regarding them are provided in the discussion of a List of Reference Numerals later in this disclosure document.

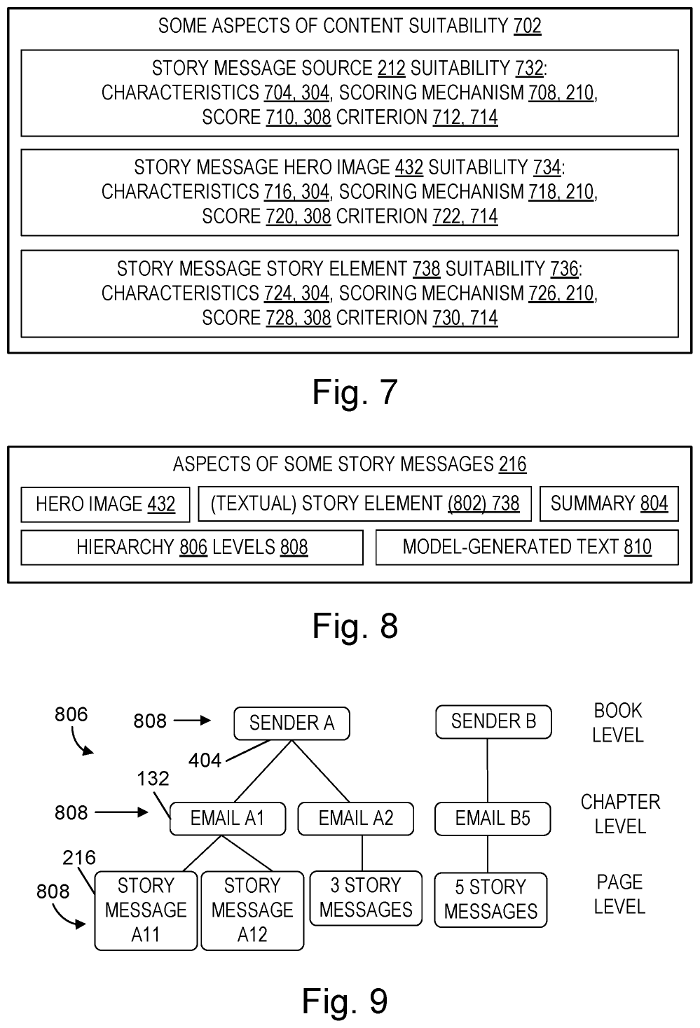

FIG. 7 shows aspects of suitability 702, including three categories of content suitability: message source suitability 732, hero image suitability 734, and story element suitability 736. This is not a comprehensive summary of all aspects of content suitability 702 which may be useful in message generation. FIG. 7 items are discussed at various points herein, and additional details regarding them are provided in the discussion of a List of Reference Numerals later in this disclosure document.

FIG. 8 shows aspects of some story messages 216. This is not a comprehensive summary of all story message 216 aspects which may be useful in message 216 generation. FIG. 8 items are discussed at various points herein, and additional details regarding them are provided in the discussion of a List of Reference Numerals later in this disclosure document.

FIG. 9 shows a hierarchical 806 organization 518 of story messages 216. This is not a comprehensive summary of all hierarchical organizations 518, or of all the ways in which story messages may be organized 518. FIG. 9 items are discussed at various points herein, and additional details regarding them are provided in the discussion of a List of Reference Numerals later in this disclosure document.

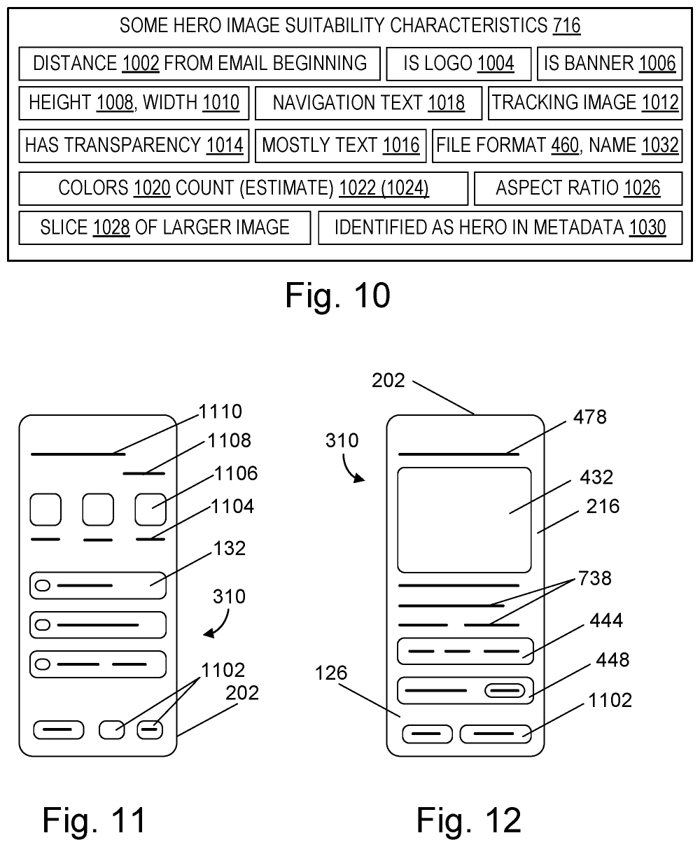

FIG. 10 shows some aspects of hero image suitability characteristics 716. This is not a comprehensive summary of all image suitability characteristics which may be useful in message 216 generation. FIG. 10 items are discussed at various points herein, and additional details regarding them are provided in the discussion of a List of Reference Numerals later in this disclosure document.

FIG. 11 shows a stylized user interface 310 of a mobile device 102, illustrating a hierarchical organization 518 of some generated hero story messages 216. This is not a comprehensive summary of all user interface aspects which may be useful in message 216 generation. FIG. 11 items are discussed at various points herein, and additional details regarding them are provided in the discussion of a List of Reference Numerals later in this disclosure document.

FIG. 12 shows a stylized user interface 310 of a mobile device 102 illustrating a generated hero story message 216. This is not a comprehensive summary of all user interface aspects which may be useful in message 216 generation, or of the layout, layout components, or visual appearance of all generated hero story messages 216. FIG. 12 items are discussed at various points herein, and additional details regarding them are provided in the discussion of a List of Reference Numerals later in this disclosure document.

In some embodiments, the enhanced system 202 may be networked through an interface 312. An interface 312 may include hardware such as network interface cards, software such as network stacks, APIs, or sockets, combination items such as network connections, or a combination thereof.

Some embodiments have a focus on the technical challenge of determining which emails 132 are suitable for use as the basis of a story message 216. For example, some software 302 checks emails for suitability 702 as the emails arrive at an email inbox 214. However, story messages can also be generated from other content sources 212, as discussed herein, such as extracts from webpages reached by following 1426 links in an email or by summarizing 1418 text of emails or webpages.

In some embodiments, an enhanced system 202 includes a computing system 202 which is configured for facilitating story message generation. The enhanced system 202 includes a digital memory 112 and a processor 110 in operable communication with the memory. The digital memory 112 may be volatile or nonvolatile or a mix. The processor 110 is configured to perform a story message generation facilitation method. The method includes (a) reading 1302 an email 132 or other message 212 which is addressed to a recipient 408 and is from a sender 404, (b) ascertaining 1304 respective values 306 of multiple story message source suitability characteristics 304 of the message, (c) submitting 1402 the story message source suitability characteristic values to a message source suitability scoring mechanism 210, (e) receiving 1404 a message source suitability score 308 from the message source suitability scoring mechanism, and (f) proceeding 1410 in a story message generation succession 1312 based on the message source suitability score. A step of proceeding in the succession (step f) could include generating 1308 a story message 216 if the message is scored as sufficiently suitable, or moving 1452 on to the next message and checking 1304, 1306 it for suitability, or if all messages have been scored then proceeding could include sleeping, suspending, or otherwise awaiting 1454 another candidate message.

Emails are used as messages 212 in many examples herein. However, source suitability 732 teachings presented herein may instead or also be beneficially applied to other sources 212 of candidate content for story message generation 1308, such as web pages, short message service messages, so-called text messages which may actually include images in many texting applications, direct messages, and posts on earlier generation social media platforms such as the FACEBOOK® platform (mark of Facebook, Inc.).

Some embodiments utilize specific story message source suitability scoring factors 304. The present disclosure lists scoring factor examples, without dictating which particular factors are used in a given implementation, or dictating what weight is given to each factor in a given implementation, or dictating how the factors are to be processed (by machine learning, by a rules engine, etc.). Once the set of factors 304 most likely to be of use in message generation 204 is understood by a developer from the teachings presented herein, an implementation or an implementation's configuration can be tuned 1456 by the developer as appropriate.

For example, suitability test tuning 1456 may lead one implementation or configuration to require that a suitable hero image be found, whereas another implementation or configuration may allow generation of messages 216 that have no hero image if the text element suitability scores 728 are sufficiently high.

Suitability test tuning 1456 may set a cutoff length 418 of the email text body at fifty words in one implementation or configuration, and at two hundred words in another. That is, emails that are longer than the cutoff are either ruled out entirely as sources 212, or they receive lowered scores 728. Emails that are too short may also be ruled out or scored lower. For instance, a given recipient may receive a large number of payment notification emails which have fewer than thirty words each, and which are not good candidates for generating story messages. Tuning 1456 which makes a text length 418 of at least thirty words serve as a suitability criterion 730 provides a rapid and efficient way to discard the payment notification emails.

Tuning 1456 may place computationally inexpensive tests 1458 ahead of more expensive tests. For example, testing 1458 an email for plain text 458, reply email status 412, password reset email status 414, and text length 418 are inexpensive in that they involve only the particular email being tested, whereas checking for the relative popularity 466 or similarity 468 of the email's content necessarily references other emails.

Similarly, tuning 1456 may perform some suitability tests in passes or phases 1460. For instance, a first pass 1460 to check whether an email has a suitable hero image may be overinclusive of images, e.g., by only checking that the email has an image 434 whose height 1008 and width 1010 are in an acceptable range, e.g., at least 150 pixels wide and at least 300 pixels high. Suppose the email scores as a suitable source 212 on the basis of that test and a few others (e.g., it is not a password reset 414, is not a reply 412, and includes at least one of: a gift card reference 454, a coupon 448, or a discount 450). Then during a second pass 1460, additional tests 1458 may be performed on the image (and in some cases on other parts of the email). For example, the image may be checked for a color count 1022 that is sufficiently high (e.g., at least twenty visually distinct colors) to rule out logos 1004, tracking images 1012, bitmapped text 1016, and navigation buttons 1102, none of which are likely to make a good hero image 432. The image may also be checked for transparency 1014 during the second phase of image suitability testing.

These are merely a few of many possible examples of testing 1458 and tuning 1456. One of skill who has the benefit of the present disclosure will recognize many other beneficial applications of the teachings disclosed herein.

Enumeration A. In some embodiments, the story message source suitability characteristics 704 include at least N of the following, where N is in a range from two to twenty depending on the embodiment: whether the email has an image 434; whether the email has a suitable hero image 432; whether the email is a reply email 412; whether the email is a password reset email 414; a length 418 of a text body 416 of the email; whether the text body 416 of the email is multi-recipient 426, e.g., it occurs in at least a thousand other emails to other recipients 408; whether the sender of the email is characterized as a human 422; whether the email is characterized as a commercial promotional email 430 based on a lookup 1462 of the sender; whether the email is characterized as a commercial promotional email 430 based on a keyword 480 in a sender address 406 of the email; whether the email is characterized as a commercial promotional email 430 based on a header 428 of the email; whether the email is characterized as a commercial promotional email 430 based on the text body 416 of the email; whether the email is characterized as a commercial promotional email 430 based on an automated content analysis 438 of an image 434 in the email; whether the email is characterized as a commercial promotional email 430 based on a coupon code 448 or a discount code 450 in the email; whether the email has a reference 454 to a gift card 452; whether the email is categorized as spam 456 by an automated spam filter mechanism 506; whether the email is categorized as malicious 462 by an automated anti-malware mechanism 514; whether the email is in a plain text 458 format; a relative popularity 466 of the email among a set of recipients 408 of the email; a relative popularity 472 of a sender of the email among a set of recipients of the email; or a similarity 468 of at least a portion of a content of the email to other content received by a recipient of the email. An email is an example of message 212, and similar characteristics 704 pertain to other messages.

An embodiment may ascertain 1304 whether an email has an image 434 by scanning for an associated file of an image type, e.g., .jpg or .jpeg, .png, .bmp, .gif, .psd, .pdf, .ai, .indd, or .raw file type. The associated file might be specified as an HTML href, be embedded, or be attached, for example, depending on the particular message source 212.

An embodiment may ascertain 1304 whether an email has a suitable hero image 432 in one or more computational phases 1460. Thus, an image 434 may be treated as suitable at a source 212 suitability testing phase and then be subject to additional criteria 722 during a subsequent hero image suitability testing phase. Hero image suitability testing may ascertain values 306 illustrated in FIG. 10, in one or more phases 1460.

An embodiment may ascertain 1304 whether an email is a reply email 412 by checking for “RE:” or a similar reply indication text in the email's subject 478, checking for an in-reply-to header 428, checking for a references header 428, checking for an email thread using a message-id and references in the header, or checking for an email thread based on email body content analysis that detects embedded addresses and subject lines, or a combination of such checking computations, for example. Reply email detection may utilize a specialized rules engine 320, a machine learning model 316 trained to classify emails as replies or not replies, or other mechanisms 502.

An embodiment may ascertain 1304 whether an email is a password reset email 414 by checking for email content such as “password”, “recover” or “reset” or “forgot”, “recently changed”, a link, and an expiration indication such as “expires” and “minutes”. Password reset email detection may utilize a specialized rules engine 320, a machine learning model 316 trained to classify emails as password resets or not, or other mechanisms 502.

An embodiment may ascertain 1304 a length 418 of a text body 416 of the email using string measurement routines such as length( ) strlen( ) or the like, in conjunction with parsing to locate the email text body start and end. Some embodiments set a suitable range for text body length as zero to 200 words.

An embodiment may ascertain 1304 whether the text body 416 of the email is multi-recipient 426 by parsing to locate the text body, and hashing or other string comparison that compares text bodies of emails. Access to emails of other recipients is available to an email service provider that provides email services to the recipients, subject to appropriate agreements, legal constraints, and privacy protections. Efficient comparison may be aided by comparing email subject hashes first and then comparing email body hashes or portions of email body texts only if the subject hashes match.

An embodiment may ascertain 1304 whether the sender of the email is characterized as a human 422 by tracing the email's path to an origin IP address and then looking up the owner of that IP address. A presumption of a human sender may be implemented in some embodiments, while a presumption of a non-human sender is implemented in some other embodiments. In some, if the IP address belongs to a residential user internet service provider, the sender is deemed human, i.e., an individual person. Otherwise, the sender is deemed a non-human entity in the sense that the sender is apparently writing on behalf of an organization of some kind rather than as an individual person. This factor may have limited utility, because promotional posts may be sent from individual sole proprietors or from larger commercial entities. However, it may still be a useful signal in conjunction with other factors.

An embodiment may ascertain 1304 whether an email is characterized as a commercial promotional email 430 based on a lookup 1462 of the sender. For instance, the names of commercial businesses which are known to send, or deemed likely to send, promotional email may be stored in a list, a search tree, or another data structure. The email sender may be parsed from the email “From” line, or may be obtained by tracing the email's path to an origin IP address and then looking up the owner of that IP address. The lookup 1462 could look up a textual name, e.g., “Contoso”, or it could look up an IP address range, or both. If the lookup finds the sender in the list or other database of commercial businesses, then the email is characterized as a commercial promotional email 430.

An embodiment may ascertain 1304 whether an email is characterized as a commercial promotional email 430 based on a keyword 480 in a sender address 406 of the email (multi-word phrases may also be keywords 480). For example, the presence of a keyword such as “no-reply”, “sale”, “news”, or “ads” in a sender address strengthens the likelihood that the email is promotional.

An embodiment may ascertain 1304 whether an email is characterized as a commercial promotional email 430 based on a header 428 of the email, e.g., by parsing to check for headers such as List-Subscribe, List-Unsubscribe, or List-Unsubscribe-Post.

An embodiment may ascertain 1304 whether an email is characterized as a commercial promotional email 430 based on the text body 416 of the email by parsing and checking for promotional email keywords 480 or indicators such as $ or another currency indicator followed by a number possibly followed by a % possibly followed by “off” or preceded by “save”; two or more consecutive $ or other currency indicators; “free”; “new”; “shop”; “buy”; “own”; “deal”; “love”; “offer”; or another signal. Additional signals which may receive less weight than the foregoing include, e.g., an exclamation, a capitalized word of at least four letters, an emoji, an ellipsis, or at least five images. Some or all of these signals may be input to a rules engine 320, a trained machine learning model 316, or another mechanism 502 that is tailored to produce a confidence level or another assessment of whether an email matching the signal values is a commercial promotional email.

An embodiment may ascertain 1304 whether an email is characterized as a commercial promotional email 430 based on an automated content analysis 438 of an image 434 in the email. For example, the image may be submitted to a computer vision mechanism 502, such as a trained machine learning model, which performs image annotation, object detection, object recognition, place recognition, people recognition, animal recognition, semantic segmentation, text recognition, or other image labeling operations. In particular, image analysis may report that an image is mostly text 1016 when the image shows text and also shows little or no non-text content such as people, animals, or objects. Such mainly-text images 1016 may be less likely to be part of a commercial promotional email, depending on their textual content, and may not be suitable for use as hero images. They are not unusual in spam. If a result of optical character recognition scanning of the image includes text such as “Sale!” or “50% off” or a brand name, then that text may be used as a story element, but the image itself is likely not suitable as a hero image.

An embodiment may ascertain 1304, e.g., by parsing and string comparison, whether an email is characterized as a commercial promotional email 430 based on a coupon code 448 or a discount code 450 in the email. Coupons 448 may be detected based on the keyword 480 “coupon” and discounts 450 may be detected based on the keyword 480 “discount”. As with other signals 306, false positives are possible, and generated 1308 messages may be subject to human review prior to being posted.

An embodiment may ascertain 1304 whether an email has a reference 454 to a gift card 452, e.g., by parsing and checking the email text for “gift card”. Some embodiments check for a visual representation of a gift card, e.g., image content that is rectangular (possibly with rounded corners) and that has an aspect ratio AR suitable for a gift card, e.g., 1.5<=AR<=1.7, where AR is defined as width divided by height.

An embodiment may ascertain 1304 whether an email is categorized as spam 456 by submitting the email to an automated spam filter mechanism 506 or based on a result of an earlier submission of the email to such a spam filter mechanism 506. As used herein, “spam” refers to unsolicited email, and has no affiliation with, endorsement of, or any other connection to, any meat product of Hormel Foods, LLC.

An embodiment may ascertain 1304 whether an email is categorized as malicious 462 by submitting the email to an automated anti-malware mechanism 514 such as an anti-virus tool 122, an anomaly detection cybersecurity tool 122, or another cybersecurity tool 122, or based on a result of an earlier submission of the email to such an anti-malware mechanism 514.

An embodiment may ascertain 1304 whether an email is in a plain text 458 format by parsing and checking for the absence of HTML or other markup language tags or syntax markers in the email body, or by checking for a MIME header setting “text/plain”. Plain text format is an alternative to HTML format.

An embodiment may ascertain 1304 a relative popularity 466 of the email among a set of recipients 408 of the email using telemetry data from recipient responses. For instance, relative popularity 466 may be calculated as the number of instances of the email which were opened divided by the number of instances of the email which were delivered. Other engagement metrics could also be part of a calculation of relative popularity 466, such as the number of recipient interactions with links or other content inside of the email. Access to email telemetry may be available to an email service provider that provides email services to the recipients, or to the email sender, subject to appropriate agreements, legal constraints, and privacy protections.

An embodiment may ascertain 1304 a relative popularity 472 of a sender of the email among a set of recipients of the email using telemetry data from recipient responses. For instance, a relative popularity 472 calculation may be based on metrics such as how many users receive messages from this sender, how often they engage with such messages, and how deep is that engagement. Engagement depth levels may include, e.g., opening the email body (level 1), clicking or tapping on links or other UI elements (level 2), and redeeming coupons (level 3). Access to email telemetry may be available to an email service provider that provides email services to the recipients, or to the email sender, subject to appropriate agreements, legal constraints, and privacy protections.

An embodiment may ascertain 1304 a similarity 468 of at least a portion of a content of the email to other content received by a recipient of the email. An embodiment may ascribe topic labels to both senders and individual email messages to provide metadata about the message content, or topics related to the sender. Using user engagement metrics, these metadata labels can serve as a basis for making predictions about which content is surfaced through stories and how that content is prioritized. Access to email telemetry may be available to an email service provider that provides email services to the recipients, or to the email sender, subject to appropriate agreements, legal constraints, and privacy protections.

Some embodiments communicate with a message source suitability scoring mechanism 210, 708, whereas other embodiments include the message source suitability scoring mechanism 210, 708. In some, the message source suitability scoring mechanism includes at least one of the following: a machine learning model 316 which has been trained using at least training values 602, 306 of the story message source suitability characteristics 704 of the email; a rules engine 320 having rules 606 which include conditional expressions 604 which collectively depend on the story message source suitability characteristic values 306; a weighted combination 608 of the story message source suitability characteristic values 306; or a statistical computation 614 which depends on the story message source suitability characteristic values 306.

For example, the machine learning model 316 may include a binary classification model trained using data 602 which includes characteristics of suitable source emails labeled as “suitable” as well as data 602 which includes characteristics of suitable source emails labeled as “not suitable”. Values 306 from actual posts which are examples of story messages 216 may serve as signals representing “suitable”. Values 306 from spam, person-specific emails, text-only emails, reply emails, password reset emails, plain text emails, and emails that lack signals such as gift card references, discounts, coupons, or sales offers, may serve as signals representing “not suitable”.

As another example, the rules engine 320 may have rules 606 such as the following:
IF (body-word-count>300) THEN result<-unsuitable, EXIT;
IF (in-header(reply) OR (in-subject(“RE:”)) THEN result<-unsuitable, EXIT;
IF (is-member(sender, vetted-senders)) THEN result<-suitable, EXIT;
. . .

As another example, the weighted combination 608 may include a calculation along the lines of the following:

email-score=has-image(candidate)*20+has-good-dimensions(candidate)*20+has-multiple-recipients(candidate)*10+looks-commercial(candidate)*40+has-link(candidate)*10;

where candidate identifies the candidate email being tested for suitability as a source 212, the has( ) functions each return zero or one, the looks-commercial( ) function returns zero or one after checking one or more of characteristics 412, 414, 430, 442, or 454, and the maximum possible score, which indicates greatest suitability 732, is one hundred. In some variations, instead of summing to at most a hundred, the weighted factors sum to at most 1.0.

As another example, the statistical computation 614 may include a calculation along the lines of the following:

IF (adherence(number-of-images(candidate), number-of-images(great-posts))) THEN suitable-email:=TRUE

where the adherence( ) function calculates a statistical measure 612 such as a statistical anomaly detection measure or a standard deviations measure to compare the values given to adherence( ) which in this example are the number of images in the candidate email and a rolling measure of the number of images in generated posts 216, 124 that received engagement above a defined threshold. Similar statistical tests may be applied to other characteristics 704.

Similar calculations may be performed for other scoring, e.g., hero image suitability scoring 720 and story element suitability scoring 728. The foregoing are merely examples, and are not presented as a comprehensive summary of all suitability scoring mechanisms 210 which may be useful in message generation.

Some embodiments communicate with one or more external scoring mechanisms 210, while other embodiments include one or more scoring mechanisms 210. For instance, computationally simpler scoring mechanisms such as those based on a weighted combination 610 or a rules engine 320 may be made part of an embodiment for ease of development or maintenance or for portability, whereas computationally complex scoring mechanisms such as those based on machine learning models 316 may remain external so they can be located on a pool of servers 102, or be shared by multiple embodiments.

Some embodiments include a hero image selection mechanism 510, including processor instructions 116, 302 which upon execution selects 1412 a hero image from a suitable email. The email is suitable by virtue of having a message source suitability score 710 which satisfies a message source suitability score criterion 712, e.g., being at least eighty out of a possible one hundred. The hero image selection mechanism 510 may include or communicate with a hero image scoring mechanism 718. The hero image selection mechanism 510 may ascertain the hero image characteristic 716 values 306 and then utilize the hero image scoring mechanism 718 to procure 1306 hero image suitability scores 720 on which hero image selection 1412 is based.

Some embodiments include a story element obtention mechanism 512, including processor instructions 116, 302 which upon execution obtains 1414 at least N story elements 738 from a suitable email, where N is in a range from one to twenty depending on the embodiment. The email is suitable by virtue of having a message source suitability score 710 which satisfies a message source suitability score criterion 712, e.g., being at least eighty out of a possible one hundred. The story element obtention mechanism 512 may include or communicate with a story element scoring mechanism 726. The story element obtention mechanism 512 may ascertain the story element characteristic 724 values 306 and then utilize the story element scoring mechanism 726 to procure 1306 story element suitability scores 728 on which story element obtention 1414 is based.

Some embodiments include a story message generation mechanism 508 including processor instructions which upon execution generates 1308 a story message based on the hero image 432 and the story elements 738.

Some embodiments include a user interface 310 organizational mechanism 518 including processor instructions 116, 302 which upon execution organize a set of story messages 216 in a hierarchy 806. FIG. 9 shows an example. The FIG. 9 hierarchy 806 has a page level 808 containing leaf nodes, a chapter level 808 above the page level, and a book level 808 above the chapter level. In this example, the story messages are grouped at the book level according to a story message sender 404 characteristic, the story messages are grouped at the chapter level according to a story message source email 212, 132 characteristic, and the story messages are located at the page level as the leaf nodes. Interaction buttons may change according to a page context, e.g., allowing a user to clip or save a coupon, be directed to a sale webpage, or download a .pdf (e.g., a ticket or coupon), and so on. Presented content may appear, disappear, or undergo changes dynamically, e.g., showing a dynamic countdown value, showing a dynamic savings percentage, removing an expired page presentation, and so on.

In the FIG. 9 example, two hero images were selected from email A1, and one story message was generated using each of them. One hero image was selected from email A2, and three story messages were generated using it. One hero image was selected from email B5, and five story messages were generated using it.

Although the tree structure of the hierarchy 806 could be displayed to a user, e.g., as nodes with connecting links resembling FIG. 9, the tree structure could also be present without links being displayed expressly. For example, FIG. 11 shows a display having three sender graphics 1106 with respective sender names 1104, representing three senders 404 at a book level 808 of a hierarchy 806.

Other system embodiments are also described herein, either directly or derivable as system versions of described processes or configured media, duly informed by the extensive discussion herein of computing hardware.

Although specific message generation facilitation architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different display 126 layouts, for example, as well as other technical features, aspects, mechanisms, rules, criteria, expressions, hierarchies, operational sequences, data structures, environment or system characteristics, or other message generation facilitation functionality 208 teachings noted herein, and may otherwise depart from the particular illustrative examples provided.

Processes (a.k.a. Methods)

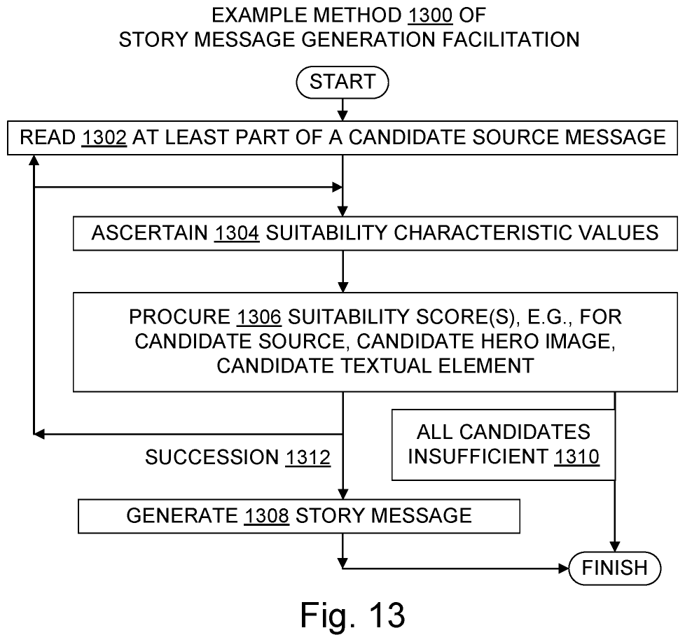

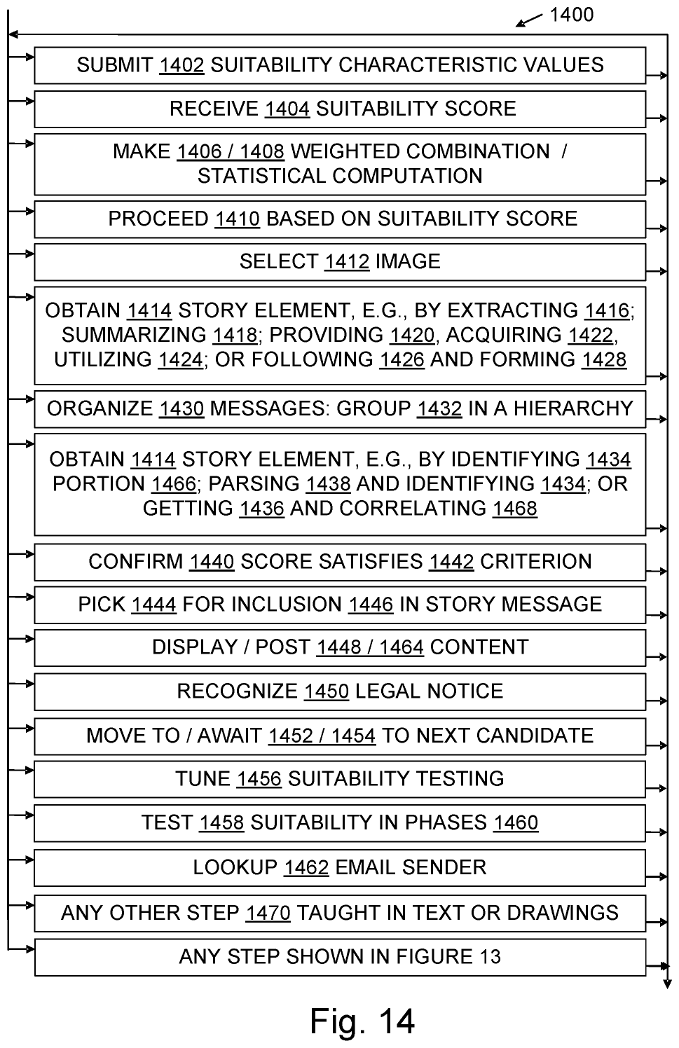

Methods (which may also be referred to as “processes” in the legal sense of that word) are illustrated in various ways herein, both in text and in drawing figures. FIGS. 13 and 14 illustrate families of methods 1300, 1400 that may be performed or assisted by an enhanced system, such as system 202 or another functionality 208 enhanced system as taught herein. FIG. 14 includes some refinements, supplements, or contextual actions for steps shown in FIG. 13, and incorporates the steps of FIG. 13 as options.

Technical processes shown in the Figures or otherwise disclosed will be performed automatically, e.g., by an enhanced system 202, unless otherwise indicated. Related processes may also be performed in part automatically and in part manually to the extent action by a human person is implicated, e.g., in some embodiments a human may review a generated message, or a human may approve (or disapprove) posting of a generated message; some human activities such as message approval or disapproval may then be represented electronically by the computer as data 118. But no process contemplated as innovative herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIGS. 13 and 14. Arrows in method or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 1300 or 1400 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments address the challenge of selecting 1412 a hero image 432 from a suitable email 132, 212. Some provide or utilize a method for story message generation facilitation, the method performed by a computing system, the method including: reading 1302 an email 132 which is addressed to a recipient 408 and is from a sender 404; selecting 1412 a candidate image 434 from the email; ascertaining 1304 respective values 306 of multiple story message hero image suitability characteristics 716 of the candidate image; submitting 1402 the story message hero image suitability characteristic values to a hero image scoring mechanism 718; receiving 1404 a message hero image suitability score 720 from the hero image scoring mechanism; and proceeding 1410 in a story message generation succession 1312 based on the message hero image suitability score.

In this example, proceeding 1410 in the succession could include generating 1308 a story message if the chosen image is scored as sufficiently heroic, or moving on 1452 to the next image and checking 1306 it for heroism 722, until a sufficiently heroic image 432 is found or until all images of the email have been checked, for instance. The succession 1312 might stop after one hero image is found, or it might try to find all of the hero images in each email, depending on which embodiment or embodiment configuration is being used.

Enumeration B. In some embodiments, the story message hero image suitability characteristics 716 include at least N of the following, with N in a range from one to fifteen depending on the embodiment: a distance 1002 of the candidate image from a beginning of the email (being closer to the top without being a banner may increase the score 720); whether the candidate image is a banner image 1006 (banners are not generally suitable as hero images); a height 1008 of the candidate image (some embodiments treat a suitable range as 300 pixels to a target display height in pixels); a width 1010 of the candidate image (some embodiments treat a suitable range as 150 pixels to a target display width in pixels); whether the candidate image is characterized as a tracking image 1012; whether the candidate image has transparency 1014; whether the candidate image is characterized as containing navigation text 1018 (UI navigation buttons are not generally suitable as hero images); whether the candidate image is characterized as containing a logo 1004 (logos are not generally suitable as hero images); an estimate 1024 or a count 1022 of how many distinct colors 1020 occur in the candidate image; a file format 460 of the candidate image; whether the candidate image is characterized 1016 as containing primarily text; an aspect ratio 1026 of the candidate image; whether the candidate image is characterized as a slice 1028 of a larger image; a presence or absence of a keyword 480 in a name 1032 of the candidate image; or whether the candidate image is identified in metadata 1030 of the email as a proposed hero image.

As to whether the candidate image is characterized as a tracking image 1012 (a.k.a. spy pixel), an embodiment may check whether the candidate image shows up as one of the few differences across a dozen or more recipients—if it does, it's probably a tracking image personalized to the recipient. An embodiment may also submit the image itself or the email as a whole to a mechanism 502 that checks for tracking images.

As to whether the candidate image has transparency 1014, the presence of transparency (e.g., an alpha channel) may decrease the score 720 because logos often have transparency and logos are not generally suitable as hero images.

As to an estimate 1024 or a count 1022 of how many distinct colors 1020 occur in the candidate image, more colors means that the image is more likely to be a photo as opposed to a computer-generated graphic such as a banner or logo or schematic. Hence more colors generally leads to a higher suitability score 720 because hero images very often include photos. Depending on the embodiment, colors may be considered distinct if any pixel components differ at all in value, or a minimum distance between respective pixel values may be needed for distinctness. An appropriate estimate 1024 supporting suitability may be, e.g., at least twenty colors, or at least thirty colors.

As to file format 460 of the candidate image, many hero images are in a lossy compression format such as .jpg rather than a lossless format such as .png, in order to reduce image file size and hence reduce image load time. Some embodiments favor particular image file formats based on statistics that indicate which file formats are used in posts 124 that receive engagement above a specified threshold.

As to whether the candidate image is characterized 1016 as containing primarily text, embodiments may use different thresholds, e.g., whether more than half the image area is in one or more lines of text, each line of text being treated as a rectangular area. An embodiment may also submit an image to an optical character recognition (OCR) mechanism 502 and then check the resultant text to see if any dictionary words were found. If OCR processing produces words found in a dictionary, then the image is treated as mostly text. An image that is text alone, or mostly alone, is not generally suitable as a hero image.

As to an aspect ratio 1026 of the candidate image, scoring may favor images that will fit nicely in a story message, and may favor portrait mode over landscape mode. Checking aspect ratio also helps avoid banners, since they tend to have an aspect ratio (width divided by height) of 2.0 or higher, with some banners having aspect ratios of 6.0 or more.

As to whether the candidate image is characterized as a slice 1028 of a larger image, sometimes an image is sliced into pieces to meet download size constraints. An image slice generally looks incomplete or erroneous and thus is not usually a suitable hero image. However, image slices can be reassembled to recreate the original full image, and then the full image can be rescored and considered for use as a hero image.

As to a presence or absence of a keyword 480 in a name 1032 of the candidate image, keywords such as “nav”, “banner”, “logo”, or “news” may tend to decrease the suitability score 720, while keywords such as “hero”, “ad”, or “campaign” may tend to increase the score 720.

The foregoing are merely some examples of hero image scoring factors. This description of factors 716 does not dictate which particular factors are used, or what weight is given to each factor, or how the factors are processed (by machine learning, a rules engine, etc.) in a given embodiment.

In some embodiments, proceeding 1410 in the story message generation succession includes: selecting 1412 the candidate image as a hero image based on at least the message hero image suitability score; obtaining 1414 at least one additional story element from the email; and generating 1308 a story message based on at least the hero image and the additional story element.

In some embodiments, proceeding 1410 in the story message generation succession includes obtaining 1414 at least one story element from the email, and the obtaining includes at least one of the following: extracting 1416 the story element from a portion 1466 of the email (e.g., body or header; may extract text per se or a widget 444 or a link 420); extracting 1416 at least one of the following constraint story elements from the email: a countdown timer 444, or product pricing information 446, 448, or 450; summarizing 1418 a text portion 1466 of the email to form the textual story element 802 (e.g., using a text summarizer mechanism 502); providing 1420 a text portion 1466 of the email to a language model mechanism 516 (e.g., GPT-3), acquiring 1422 a model-generated text from the language model mechanism in response to the providing, and utilizing 1424 at least a portion 1466 of the model-generated text as a textual story element 802; or following 1426 a hyperlink 420 of a hero image to a destination (e.g., a web page), and forming 1428 a textual story element based at least in part on data located at the destination (e.g., text from the top of the web page reached by clicking the image's link).

In some embodiments, proceeding 1410 in the story message generation succession includes obtaining a story element, and the obtaining includes at least one of the following: identifying 1434 a first portion 1466 of text as being nearer a beginning 476 of the email message than a second portion 1466 of text; parsing 1438 a markup language representation 424 of the email, and identifying 1434 a text which is configured in the markup language representation to be displayed within five text line heights 474 of an image; or getting 1436 a hero image content description 440 from an automated content analysis of a hero image of the email, and correlating 1468 a textual story element with the hero image content description (e.g., the analysis result includes “dog” and the textual story element likewise includes “dog”).

As to the identifying 1434 and related action, selection may favor text near the top of the source email. For this purpose the first displayed subject line or other portion of a header may be considered the beginning of the email.

As to the parsing 1438 and related action, an example would include finding HTML text chunks and favoring text that displays near the hero image in the source email. Nearness may be defined as within N text line heights, e.g., with N in a range from two to eight, depending on the embodiment.

In some embodiments, the method includes: ascertaining 1304 respective values of multiple story message source suitability characteristics 704 of the email; submitting 1402 the story message source suitability characteristic values to a message source suitability scoring mechanism 708; receiving 1404 a message source suitability score 710 from the message source suitability scoring mechanism; and confirming 1440 that the message source suitability score satisfies a message source suitability score criterion 712. In some, selecting 1412 the candidate image from the email occurs after the confirming 1440.

In some embodiments, the story message source suitability characteristics 704 include at least N of the following, where N is in a range of one to six depending on the embodiment: whether the email is characterized 430 as a commercial promotional email based on a lookup of the sender 1462; whether the email is characterized 430 as a commercial promotional email based on a keyword 480 in a sender address 406 of the email; whether the email is characterized 430 as a commercial promotional email based on a header 428 of the email; a relative popularity 466 of the email among a set of recipients of the email; a relative popularity 472 of a sender of the email among a set of recipients of the email; or a similarity 468 of at least a portion of a content of the email to other content received by a recipient of the email.

In some embodiments, the story message hero image suitability characteristics include at least N of the following, where N is in a range of one to twelve depending on the embodiment: a distance 1002 of the candidate image from a beginning of the email; whether the candidate image is a banner image 1006; whether the candidate image is characterized as a tracking image 1012; whether the candidate image has transparency 1014; whether the candidate image is characterized as containing navigation text 1018; whether the candidate image is characterized as containing a logo 1004; an estimate 1024 or a count 1022 of how many distinct colors 1020 occur in the candidate image; a file format 460 of the candidate image; a presence or absence of a keyword 480 in a name of the candidate image; whether the candidate image is characterized 1016 as containing primarily text; whether the candidate image is characterized 1028 as a slice of a larger image; or whether the candidate image is identified in metadata 1030 of the email as a proposed hero image.

In some embodiments, proceeding 1410 in the story message generation succession 1312 includes obtaining 1414 a story element, and the obtaining includes at least one of the following: procuring 1306 a candidate textual story element score 728 from a scoring mechanism 726; summarizing 1418 a text portion of the email to form a textual story element 802, 738 as the story element; providing 1420 a text portion of the email to a language model mechanism, acquiring 1422 a model-generated text from the language model mechanism in response to the providing, and utilizing 1424 at least a portion of the model-generated text as the a textual story element in the story element; or following 1426 a hyperlink of the email to a destination, and forming 1428 a textual story element portion of the story element based at least in part on data located at the destination.

In some embodiments, the method includes at least N of the following, where N is in a range of one to four depending on the embodiment: picking 1444 for inclusion in a story message a first portion of text rather than a second portion of text, the first portion of text being nearer a beginning of the email message than the second portion of text; parsing 1438 a markup language representation of the email, and picking 1444 for inclusion in a story message a text which is configured in the markup language representation to be displayed within ten text line heights of a hero image; recognizing 1450 a legal notice portion 1466 of the email, and picking 1444 the legal notice portion for inclusion in a story message; or getting 1436 a hero image content description from an automated content analysis of a hero image of the email, and picking 1444 for inclusion in a story message a textual story element which is correlated with the hero image content description.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as story message generation software 302, suitability characteristic values 306, suitability scoring mechanisms 210, suitability scores 308, user interface organization mechanisms 518, and generated 1308 story messages 216, in the form of data 118 and instructions 116, read from a removable storage medium 114 and/or another source such as a network connection, to form a configured storage medium. The configured storage medium 112 is capable of causing a computer system 102 to perform technical process steps for story message generation facilitation, as disclosed herein. The Figures thus help illustrate configured storage media embodiments and process (a.k.a. method) embodiments, as well as system and process embodiments. In particular, any of the process steps illustrated in FIG. 13 or 14, or otherwise taught herein, may be used to help configure a storage medium to form a configured storage medium embodiment.

Some embodiments use or provide a computer-readable storage device 112, 114 configured with data 118 and instructions 116 which upon execution by at least one processor 110 cause a computing system to perform a method for story message generation facilitation. This method includes: reading 1302 a candidate message 212; ascertaining 1304 respective values of multiple suitability characteristics of the candidate message; submitting 1402 the suitability characteristic values to a suitability scoring mechanism; receiving 1404 from the suitability scoring mechanism at least one of the following suitability scores: a message source suitability score 710, a message hero image suitability score 720, or a message story element suitability score 728; and proceeding 1410 in a story message generation succession based on the suitability score.

In some embodiments the method includes receiving 1404 at least two of the suitability scores, and proceeding 1410 in the story message generation succession based on the suitability scores.

In some embodiments, the ascertaining 1304 includes ascertaining values of N story message source suitability characteristics 704, where N is at least three but not more than ten, depending on the embodiment.

In some embodiments, the ascertaining 1304 includes ascertaining values of N message hero image suitability characteristics 716, where N is at least five but not more than twelve, depending on the embodiment.

In some embodiments, the ascertaining 1304 includes ascertaining values of N story message story element suitability characteristics 724, where N is at least four but not more than eleven, depending on the embodiment.

Additional Observations

Additional support for the discussion of story message generation facilitation functionality 208 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, examples and observations are offered herein.

Technical Character

The technical character of embodiments described herein will be apparent to one of ordinary skill in the art, and will also be apparent in several ways to a wide range of attentive readers. Some embodiments address technical activities such as ascertaining 1304 characteristics 304 of digital artifacts 132, 434, 738, organizing 518 a user interface 310, parsing 1438 data 118, generating 1308 social media posts or other story messages 216, or utilizing various computational mechanisms 502, which are each an activity deeply rooted in computing technology. Some of the technical mechanisms discussed include, e.g., story message generation facilitation software 302, user interfaces 310, trained machine learning models 316, rules engines 320, spam filters 506, anti-malware tools 514, and suitability scoring mechanisms 210. Some of the technical effects discussed include, e.g., story messages 216 having hero images 432 and story elements 738 that have been derived automatically from more complex or verbose emails 132 which are not likely to receive as much viewer engagement as the story messages 216 if they were posted or displayed directly instead of being transformed 1400 as taught herein, a hierarchy 806 which organizes story messages 216 according to sender 404 and underlying email 132, 212, and objective computable criteria 714 which describe desirable and undesirable characteristics 304 of story messages 216. Thus, purely mental processes and activities limited to pen-and-paper are clearly excluded. Other advantages based on the technical characteristics of the teachings will also be apparent to one of skill from the description provided.

Different embodiments may provide different technical benefits or other advantages in different circumstances, but one of skill informed by the teachings herein will acknowledge that particular technical advantages will likely follow from particular innovation features or feature combinations.

For example, scoring 1306 the suitability of an email 132 for use in generating a story message permits automated consideration of many emails as potential sources 212 of a story message 216, with few false positives receiving a score 710 that leads to their immediate deletion after being displayed 1448 in an inbox 214, or leads to human review followed by their rejection rather than being posted 1464 on a social media network. False positives may be based, e.g., on users marking or treating a generated message as confusing, erroneous, not helpful, or annoying, or may be based on the failure of a generated message to any receive any user engagement other than being deleted. Email content not suitable for a post or other story message 216 is automatically discarded and need not be reviewed by a person. Similarly, scoring 1306 the suitability of an email image as a hero image permits automated consideration of many images 434 as potential hero images 432, with few false positives receiving a score 720 that leads to human review and rejection. Likewise, scoring 1306 the suitability of an email story element 738 candidate permits automated consideration of many story elements 802 as potential message 216 content 464, with few false positives.

Moreover, enumerating story message source suitability characteristics 704 as done, for example, in FIG. 4 or Enumeration A, provides a basis for a computable and tunable 1456 mechanism 502 that separates emails containing suitable story message content 464 from personal emails (e.g., email from a landlord, or replies), spam 456, administrative emails (e.g., password resets, payment notices), and other non-promotional emails. Similarly, enumerating hero image suitability characteristics 716 as done, for example, in FIG. 10 or Enumeration B, provides a basis for a computable and tunable 1456 mechanism 502 that separates email images containing suitable hero image content 464 from logos 1004, banners 1006, tracking images 1012, images 1016 that hold little except text, navigation buttons 1018, and other images 434 that are unlikely to promote viewer engagement if displayed as a visual hook to try and catch a viewer's attention.

Other benefits of particular steps or mechanisms of an embodiment are also noted elsewhere herein in connection with those steps or mechanisms.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to efficiently and effectively screen emails 132 for content that can be transformed automatically into the style of a post 124, for subsequent posting 1464 or inbox display 1448. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples, operating environments, peripherals, time examples, software process flows, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
GUID: globally unique identifier
HTML: hypertext markup language
HTTPS: hypertext transfer protocol, secure
laaS or IAAS: infrastructure-as-a-service
ID: identification or identity
LAN: local area network
MIME: multipurpose internet mail extension
OS: operating system
PaaS or PAAS: platform-as-a-service
RAM: random access memory
ROM: read only memory
TPU: tensor processing unit
UEFI: Unified Extensible Firmware Interface
UI: user interface
URI: uniform resource identifier
URL: uniform resource locator
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (laaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Message generation facilitation operations such as ascertaining 1304 suitability characteristic values 306, procuring 1306 suitability scores 308, communicating 1402, 1404 with mechanisms 502, and many other operations discussed herein, are understood to be inherently digital. A human mind cannot interface directly with a CPU or other processor, or with RAM or other digital storage, to read and write the necessary data to perform the story message generation facilitation steps taught herein even in a hypothetical prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as acquiring, ascertaining, awaiting, confirming, correlating, displaying, extracting, following, forming, generating, getting, grouping, identifying, looking up, making, moving to, obtaining, organizing, parsing, picking, proceeding, procuring, providing, reading, receiving, recognizing, selecting, submitting, summarizing, testing, tuning, utilizing (and acquires, acquired, ascertains, ascertained, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
102 computer system, also referred to as a “computational system” or “computing system”, and when in a network may be referred to as a “node”
104 users, e.g., user of an enhanced system 202; refers to a human or a human's online identity unless otherwise stated
106 peripheral device
108 network generally, including, e.g., LANs, WANs, software-defined networks, clouds, and other wired or wireless networks
110 processor; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102
120 kernel(s), e.g., operating system(s), BIOS, UEFI, device drivers
122 tools, e.g., cybersecurity tools, software development tools, office productivity tools, social media tools, diagnostics, browsers, games, email and other communication tools, commands, and so on
124 social media messages, e.g., posts, direct messages, blogs, vlogs, articles, electronic books, videos, photos, live streams, infographics, reviews, testimonials, announcements, contests, comments; digital artifacts as opposed to paper or unrecorded voice or images
126 display screens, also referred to as “displays”
128 computing hardware not otherwise associated with a reference number 106, 108, 110, 112, 114
130 social media software, e.g., websites, apps, or other software intended to create, edit, transmit, or display social media messages 124
132 email; digital artifacts
134 cloud, cloud computing environment; unless stated otherwise, clouds are multitenant and thus include multiple environments
202 system 102 enhanced with story message generation facilitation functionality 208
204 story message generation; includes computational activity
206 story message generation facilitation; includes computational activity; includes story message generation 204 or computational activity which facilitates story message generation 204, e.g., ascertaining suitability characteristic values, procuring suitability scores, or both
208 story message generation facilitation functionality, e.g., software or specialized hardware which performs or is configured to perform story message generation facilitation, e.g., software 302, or any software or hardware which performs or is configured to perform a method 1300 or story message generation facilitation activity first disclosed herein
210 suitability scoring mechanism; a mechanism 502 tailored to compute a suitability score 308
212 message source, e.g., emails, posts, direct messages, short message service messages, or other digital content; may also be referred to as messages 212
214 message source store, e.g., email in box, email or other message repository; digital
216 story message; a digital artifact which satisfies at least one criterion 722 or 730 according to at least one scoring mechanism 718 or 726
302 story message generation software, e.g., software which upon execution in a computing system 102 provides functionality 208 in the form of at least one of: a scoring mechanism 210, a story generation mechanism 508, a hero image selection mechanism 510, or a story element obtention mechanism 512
304 suitability characteristic of a message source 212, an image 434, or a story element 738; embodied in data 118 or a data structure or both
306 suitability characteristic value; digital
308 suitability score; digital; based on one or more values 306
310 user interface; software operating in conjunction with hardware
312 interface generally; operates computationally
314 interface to a machine learning model, e.g., an API
316 trained machine learning model; operates computationally
318 interface to a rules engine, e.g., an API
320 rules engine; operates computationally
404 sender of email or other message 212; represented digitally
406 address of sender 404, e.g., email address; digital
408 recipient of email or other message 212; represented digitally
410 address of recipient 408, e.g., email address; digital
412 status of being a reply email or other reply message; an example of a characteristic 704; represented digitally
414 status of being a password reset email or other password reset message; an example of a characteristic 704; represented digitally
416 body of an email or other message, as opposed to header or metadata; may include text, images, links, and other content represented digitally
418 length of text in a body 416; digital value; may be measured in characters or words or lines, for example
420 hyperlink, e.g., digital textual representation of a URL or URI; may also be called a “link”
422 status of having a human sender in the sense that the sender 404 represents an individual person as opposed to a legal juristic person or a bot; an example of a characteristic 704; represented digitally
424 status of including markup language, e.g., HTML, may also refer to an instance of markup language; an example of a characteristic 704; represented digitally
426 status of being an instance of a multi-recipient message; may also refer to an instance of a multi-recipient message; may occur despite differences between instances that distinguish the recipients from one another, e.g., recipient address 410 and tracking image 1012; an example of a characteristic 704; represented digitally
428 header portion of email or other message; may represent or support one multiple characteristics 704; represented digitally
430 digitally represented status or computational action of being characterized as a commercial promotional message; an example of a characteristic 704; may also refer to a message which has such status
432 hero image, e.g., an image which an embodiment treats 1410 as suitable 734 for use as a hero image based on values 306 of the image; represented digitally
434 image generally, whether characterized as a hero image or not; “image” herein refers to still images as well as moving images such as those found in .gif format files or in .avi, .mov, .wmv, .mpg or other video file formats; images are digital artifacts; may have ascertainable values for characteristics 704 or 716
436 image content; represented digitally
438 image content analysis; performed computationally
440 image content analysis result, e.g., digital textual description of at least some content of an image; an example of a characteristic 704 or 716
442 constraint characteristic 704, e.g., constraint on how long a sale lasts, how many items are available for purchase, maximum price an item will cost, who is eligible to purchase an item, or another aspect of a commercial transaction; represented digitally; an example of a characteristic 704;
444 time or item countdown; an example of a constraint characteristic
446 item or service price; an example of a constraint characteristic
448 coupon; an example of a constraint characteristic
450 discount; an example of a constraint characteristic
452 gift card; an example of a characteristic 704; represented digitally
454 reference to a gift card, e.g., embedded gift card, gift card number, or link to a gift card; represented digitally; an example of a characteristic 704;
456 digitally represented status or computational action of being characterized as an unsolicited commercial message by a mechanism 506; an example of a characteristic 704 or 716 or 724; may be referred to as “spam” with the understanding that it has no affiliation with, endorsement of, or any other connection to, any meat product of Hormel Foods, LLC.
458 digitally represented status or computational action of being characterized as plain text, as opposed to text with a markup language; an example of a characteristic 704
460 message format generally; represented digitally
462 digitally represented status or computational action of being characterized as malicious by a mechanism 514; an example of a characteristic 704 or 716 or 724
464 message content characteristic 704 or 716 or 724; represented digitally
466 a characteristic 464 representing relative popularity of message content (text, image, or other story element)
468 a characteristic 464 representing relative similarity of message content (text, image, or other story element)
470 legal notice, e.g., copyright notice, trademark notice, patent notice, or text having impact on legal rights or obligations in the relevant jurisdiction; represented digitally; an example of a characteristic 704 or 716 or 724
472 a characteristic 704 or 716 or 724 representing relative popularity of message sender; represented digitally
474 a characteristic 704 or 724 representing distance between respective baselines of two lines of text; digital value; may vary within a given message or even within a given textual story element
476 beginning of a displayed portion of a message; represented digitally
478 subject line or content thereof, of a message; represented digitally
480 keyword; may include a phrase, despite the name; represented digitally
502 mechanisms generally; in the present disclosure, “mechanism” refers to software or specialized hardware which performs or is configured to perform computational activity
506 a spam 456 identification or filtering mechanism 502
508 a story message generation mechanism 502, which includes functionality to perform story message generation 1308
510 a hero image selection mechanism 502, which includes functionality to perform hero image 432 selection 1412
512 a story element obtention mechanism 502, which includes functionality to perform story element 738 obtention 1414
514 a malicious software identification or filtering mechanism 502
516 a language model, e.g., GPT-3, GPT-Neo, GPT-J, Wu Dao 2.0, or Al21; computational
518 a user interface organization mechanism 502, or a tree or other organizational data structure, which organizes messages 216 for user navigation
602 machine learning model training data; digital
604 conditional expression; computation which involves a conditional such as IF or WHEN and an expression that evaluates to a value
606 rule; digital artifact
608 weight in a computational sum or product, or computational action of weighting one or more parts of a computational sum or product
610 arithmetic combination of values, e.g., computational sum or product
612 statistical function or value; computational
614 statistical computation
702 story message content suitability generally, as represented digitally in a system
704 story message source suitability characteristics, which may be used to assess the suitability of an email or other message as a source 212 of content for a generated story message
708 story message source suitability scoring mechanism; an example of a scoring mechanism 210
710 story message source suitability score; digital
712 story message source suitability score criterion, e.g., “for a message to be considered suitable as a source 212 the message must have a story message source suitability score of at least 75 out of a possible 100”, or “for a message to be considered suitable it must not include a password reset message”; an example of a criterion 714
714 suitability score criterion generally, as represented digitally in a system
716 hero image suitability characteristics, which may be used to assess the suitability of an image for use as a hero image in a generated story message
718 hero image suitability scoring mechanism; an example of a scoring mechanism 210
720 hero image suitability score; digital
722 hero image suitability score criterion, e.g., “for an image to be considered suitable as a hero image 432 the image must have a hero image suitability score of at least 60 out of a possible 100”, or “for an image to be considered suitable it must not include a tracking image”; an example of a criterion 714
724 story element suitability characteristics, which may be used to assess the suitability of a message element for use as a story element in a generated story message
726 story element suitability scoring mechanism; an example of a scoring mechanism 210
728 story element suitability score; digital
730 story element suitability score criterion, e.g., “for a portion of source message text to be considered suitable as a story element the portion must have a story element suitability score of at least 95 out of a possible 100”, or “a constraint 442 widget or a gift card widget 454 is always considered suitable”; an example of a criterion 714
732 story message source suitability generally, e.g., associated computations or computational results
734 hero image suitability generally, e.g., associated computations or computational results
736 story element suitability generally, e.g., associated computations or computational results
738 story element; digital; an embodiment may treat images as story elements but images are assessed separately from text elements and widget elements 454, 442 unless indicated otherwise; story elements thus include images, widgets such as gift card or discounts, textual story elements such as text next to or laid over an image, and links, for example
802 textual story elements, e.g., a story element which is mostly or entirely text
804 summary text, e.g., automatically generated textual summary of a larger text; digital
806 hierarchy, e.g., one or more trees or other ordered graphs having nodes that represent story messages
808 levels in a hierarchy 806
810 model-generated text, e.g., text automatically generated by a language model 516; digital
1002 distance in a message; may be in terms of words, characters, line heights, or pixels, for example; digital
1004 digitally represented status or computational action of being characterized as a logo by a mechanism 502; an example of a characteristic 716 or 724
1006 digitally represented status or computational action of being characterized as a banner by a mechanism 502; an example of a characteristic 716 or 724
1008 image height, e.g., in pixels; digital; an example of a characteristic 716 or 724
1010 image width, e.g., in pixels; digital; an example of a characteristic 716 or 724
1012 digitally represented status or computational action of being characterized as a tracking image by a mechanism 502; an example of a characteristic 716 or 724
1014 digitally represented status or computational action of being characterized as an image which has transparency by a mechanism 502; an example of a characteristic 716 or 724
1016 digitally represented status or computational action of being characterized as an image which is mostly text by a mechanism 502; an example of a characteristic 716 or 724
1018 digitally represented status or computational action of being characterized as an image having navigation text such as “next”, “back”, “home”, or the like by a mechanism 502; an example of a characteristic 716 or 724
1020 color, e.g., as represented digitally by pixel component values; may be in any color space
1022 count of colors; digital; an example of a characteristic 716 or 724
1024 estimated count of colors; digital; an example of a characteristic 716 or 724
1026 image aspect ratio; digital; an example of a characteristic 716 or 724
1028 digitally represented status or computational action of being characterized as a slice of a larger image by a mechanism 502; an example of a characteristic 716 or 724
1030 metadata of a message or a story element; digital; header content and MIME content are examples of metadata
1032 image name; digital; may include an URL
1102 navigation button; digital
1104 sender name; digital
1106 sender photo, logo, or other graphic; digital
1108 date; digital
1110 recipient name; digital
1300 flowchart; 1300 also refers to story message generation facilitation methods illustrated by or consistent with the FIG. 13 flowchart
1302 read a least a portion of a candidate source 212; performed computationally, e.g., using a file system or other API
1304 computationally ascertain values of suitability characteristics, e.g., by parsing, extraction, checking header, checking body, communicating with mechanisms 506, 514, or other processing in a system
1306 computationally procure one or more suitability scores 710, 720, 728, e.g., by submitting 1402 characteristic values to one or more mechanisms 708, 718, 726 and receiving 1404 corresponding score(s)
1308 computationally generate a message 216 by including suitable content in a data structure template for the message
1310 computationally determine that there are currently insufficient available suitable story elements (images, textual elements, widgets, links) to computationally generate 1308 a message
1312 succession in method 1300 computations; represented in software
1400 flowchart; 1400 also refers to story message generation facilitation methods illustrated by or consistent with the FIG. 14 flowchart (which incorporates the steps of FIG. 13)
1402 computationally submit suitability characteristic values to a mechanism, e.g., via an API
1404 computationally receive a suitability characteristic score from a mechanism, e.g., via an API
1406 compute a weighted combination 610 in a system
1408 perform a statistical computation 614 in a system
1410 computationally proceed in a succession 1312 based on one or more suitability scores
1412 computationally select an image
1414 computationally obtain a story element
1416 computationally extract data from a message or other data structure
1418 computationally summarize text to produce a summary
1420 computationally provide a result
1422 computationally acquire data
1424 computationally utilize data
1426 computationally follow a link to a destination
1428 computationally form a story element using data from a link destination
1430 computationally organize message for presentation via a user interface
1432 computationally group message, e.g., into levels
1434 computationally identify a story element candidate
1436 computationally get a hero image content description, e.g., by extraction or via an API
1438 computationally parse a markup language structure or other data structure
1440 computationally confirm (check) whether a criterion is satisfied
1442 computationally confirm (establish) that a criterion is satisfied
1444 computationally pick data for inclusion in a message 216
1446 computationally include data in a message; also refers to state of being included in a message
1448 computationally display data, e.g., using a display 126
1450 computationally recognize a legal notice, e.g., using a regular expression or other parsing mechanism
1452 computationally move an instruction pointer to a point of processing another candidate story element or candidate message source
1454 computationally await another candidate story element or candidate message source, e.g., by awaiting a signal or an interrupt
1456 computationally tune suitability testing, e.g., by changing which characteristics 304 have their values ascertained, which criteria 714 are applied to scores 308, or both
1458 computationally test suitability 702 in phases, e.g., by tuning 1456 and then reapplying the tuned computation to the same image or the same textual story element
1460 computational phase of suitability testing
1462 computationally look up an email sender, e.g., by name or email address or IP address
1464 computationally post a message 216 on a social media platform 108, 130
1466 portion of a message, portion of a text; digital
1468 computationally correlate a text and an image
1470 any step discussed in the present disclosure that has not been assigned some other reference numeral

### CONCLUSION

In short, the teachings herein provide a variety of story message generation facilitation functionalities 208 which operate in enhanced systems 202. Social media posts 124, 216 and other generated messages 216 may include a hero image 432 and other story elements 738, such as text, links 420, coupons 448 or discounts 450, countdowns 444, or gift card references 454. Hero image 432 selection mechanisms 510 and story element obtention mechanisms 512 are described, with discussion of mechanisms 502 that can be tuned 1456 to objectively define a social media content 464 style that is consistent with pre-existing posts 124 on portable devices 102. Criteria sets 714, scoring factors 304, 306, and suitability scoring mechanisms 210 are provided for testing 1458 the suitability of emails 132 and other messages 212 as sources of content 432, 738 for automatically generating 1308 social media posts 124, 216 and other story messages 216. Example user interface 310 organization mechanisms 518 and layouts (FIGS. 11 and 12) are described. The various mechanisms 502 permit fully or largely automatic testing 1458 of candidate emails 132, candidate images 434, and candidate texts, for example, in a manner that filters out 1310 unsuitable content and thereby avoids overburdening a human reviewer 104 with false positive attempts at generated messages 216.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIG. 13 or 14 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; innovators are not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system which is configured to facilitate story message generation, comprising:
a digital memory;
a processor in operable communication with the digital memory, the processor configured to perform story message generation facilitation including: (a) reading a message which is addressed to a recipient and is from a sender, (b) ascertaining respective values of multiple story message source suitability characteristics of the message, (c) submitting the story message source suitability characteristic values to a message source suitability scoring mechanism, (e) receiving a message source suitability score from the message source suitability scoring mechanism, and (f) proceeding in a story message generation succession based on the message source suitability score; and
a hero image selection mechanism including processor instructions which upon execution select a hero image from a suitable message, the hero image selection based on at least two of the following hero image suitability characteristics: a distance of the hero image from a beginning of the suitable message, whether the hero image is a banner image, whether the hero image is characterized as a tracking image, whether the hero image has transparency, whether the hero image is characterized as containing navigation text, whether the hero image is characterized as containing a logo, a file format of the hero image with a corresponding engagement statistic, whether the hero image is characterized as containing primarily text, or whether the hero image is identified in a metadata of the suitable message as a proposed hero image.

2. The system of claim 1, wherein the story message source suitability characteristics include at least four of the following:
whether the message has an image;
whether the message has a suitable hero image;
whether the message includes a reply email;
whether the message includes a password reset email;
a length of a text body of the message;
whether the text body of the message occurs in at least a thousand other messages to other recipients;
whether the sender of the message is characterized as a human;
whether the message is characterized as a commercial promotional message based on a lookup of the sender;
whether the message is characterized as a commercial promotional message based on a keyword in a sender address of the message;
whether the message is characterized as a commercial promotional message based on a header of the email;
whether the message is characterized as a commercial promotional message based on the text body of the message;
whether the message is characterized as a commercial promotional message based on an automated content analysis of an image in the message;
whether the message is characterized as a commercial promotional message based on a coupon code or a discount code in the message;
whether the message has a reference to a gift card;
whether the message is categorized as spam by an automated spam filter mechanism;
whether the message is categorized as malicious by an automated anti-malware mechanism;
whether the message is in a plain text format;
a relative popularity of the message among a set of recipients of the message;
a relative popularity of a sender of the message among a set of recipients of the message; or
a similarity of at least a portion of a content of the message to other content received by a recipient of the message.

3. The system of claim 1, further comprising the message source suitability scoring mechanism, and wherein the message source suitability scoring mechanism includes at least one of the following:
a machine learning model which has been trained using at least training values of the story message source suitability characteristics of the message;
a rules engine having rules which include conditional expressions which collectively depend on the story message source suitability characteristic values;
a weighted combination of the story message source suitability characteristic values; or
a statistical computation which depends on the story message source suitability characteristic values.

4. The system of claim 1, further comprising:
a story element obtention mechanism including processor instructions which upon execution obtains at least two story elements of the suitable message; and
a story message generation mechanism including processor instructions which upon execution generates a story message based on the hero image and the story elements.

5. The system of claim 1, further comprising a user interface organizational mechanism including processor instructions which upon execution organize a set of story messages in a hierarchy, the hierarchy having a page level containing leaf nodes, a chapter level above the page level, and a book level above the chapter level, wherein the story messages are grouped at the book level according to a story message sender characteristic, the story messages are grouped at the chapter level according to a story message source message characteristic, and the story messages are located at the page level as the leaf nodes.

6. A method for story message generation facilitation, the method performed by a computing system, the method comprising:
reading a message which is addressed to a recipient and is from a sender;
selecting a candidate image from the message;
ascertaining respective values of multiple story message hero image suitability characteristics of the candidate image, including ascertaining at least two of the following candidate image suitability characteristics: a distance of the candidate image from a beginning of the message, whether the candidate image is a banner image, whether the candidate image is characterized as a tracking image, whether the candidate image has transparency, whether the candidate image is characterized as containing navigation text, whether the candidate image is characterized as containing a logo, a file format of the candidate image with a corresponding engagement statistic, whether the candidate image is characterized as containing primarily text, or whether the candidate image is identified in a metadata of the message as a proposed hero image;
submitting the ascertained story message hero image suitability characteristic values to a hero image scoring mechanism;
receiving a message hero image suitability score from the hero image scoring mechanism; and
proceeding in a story message generation succession based on the message hero image suitability score.

7. The method of claim 6, wherein the story message hero image suitability characteristics further include at least one of the following:
a height of the candidate image;
a width of the candidate image;
an estimate or a count of how many distinct colors occur in the candidate image;
an aspect ratio of the candidate image; or
whether the candidate image is characterized as a slice of a larger image.

8. The method of claim 6, wherein proceeding in the story message generation succession comprises:
selecting the candidate image as a hero image based on at least the message hero image suitability score;
obtaining at least one additional story element from the message; and
generating a story message based on at least the hero image and the additional story element.

9. The method of claim 6, wherein proceeding in the story message generation succession comprises obtaining at least one story element from the message, and wherein obtaining comprises at least one of the following:
extracting a textual story element from a text portion of the message for use as the story element;
extracting at least one of the following constraint story elements from the message: a countdown timer, or product pricing information;
summarizing a text portion of the message to form a textual story element for use as the story element;
providing a text portion of the message to a language model mechanism, acquiring a model-generated text from the language model mechanism in response to the providing, and utilizing at least a portion of the model-generated text as a textual story element portion of the story element; or
following a hyperlink of a hero image to a destination, and forming the story element based at least in part on data located at the destination.

10. The method of claim 6, wherein proceeding in the story message generation succession comprises obtaining a textual story element, and wherein the obtaining comprises at least one of the following:
identifying a first portion of text as being nearer a beginning of the message than a second portion of text;
parsing a markup language representation of the message, and identifying a text which is configured in the markup language representation to be displayed within five text line heights of an image; or
getting a hero image content description from an automated content analysis of a hero image of the message, and correlating the textual story element with the hero image content description.

11. The method of claim 6, further comprising:
ascertaining respective values of multiple story message source suitability characteristics of the message;
submitting the story message source suitability characteristic values to a message source suitability scoring mechanism;
receiving a message source suitability score from the message source suitability scoring mechanism;
confirming that the message source suitability score satisfies a message source suitability score criterion; and
wherein selecting the candidate image from the message occurs after the confirming.

12. The method of claim 11, wherein the story message source suitability characteristics include at least one of the following:
whether the message is characterized as a commercial promotional message based on a lookup of the sender;
whether the message is characterized as a commercial promotional message based on a keyword in a sender address of the message;
whether the message is characterized as a commercial promotional message based on a header of the message;
a relative popularity of the message among a set of recipients of the message;
a relative popularity of a sender of the message among a set of recipients of the message; or
a similarity of at least a portion of a content of the message to other content received by a recipient of the message.

13. The method of claim 6, wherein the story message hero image suitability characteristics include at least four of the following:
a distance of the candidate image from a beginning of the message;
whether the candidate image is a banner image;
whether the candidate image is characterized as a tracking image;
whether the candidate image has transparency;
whether the candidate image is characterized as containing navigation text;
whether the candidate image is characterized as containing a logo;
an estimate or a count of how many distinct colors occur in the candidate image;
a file format of the candidate image;
a presence or absence of a keyword in a name of the candidate image;
whether the candidate image is characterized as containing primarily text;
whether the candidate image is characterized as a slice of a larger image; or
whether the candidate image is identified in metadata of the message as a proposed hero image.

14. The method of claim 6, wherein proceeding in the story message generation succession comprises obtaining a textual story element, and wherein the obtaining comprises at least one of the following:
procuring a candidate textual story element score from a scoring mechanism;
summarizing a text portion of the message to form the textual story element;
providing a text portion of the message to a language model mechanism, acquiring a model-generated text from the language model mechanism in response to the providing, and utilizing at least a portion of the model-generated text as the textual story element; or
following a hyperlink of the email to a destination, and forming the textual story element based at least in part on data located at the destination.

15. The method of claim 6, wherein the method further comprises at least two of the following:
picking for inclusion in a story message a first portion of text rather than a second portion of text, the first portion of text being nearer a beginning of the message than the second portion of text;
parsing a markup language representation of the email, and picking for inclusion in a story message a text which is configured in the markup language representation to be displayed within ten text line heights of a hero image;
recognizing a legal notice portion of the message, and picking the legal notice portion for inclusion in a story message; or
getting a hero image content description from an automated content analysis of a hero image of the message, and picking for inclusion in a story message a textual story element which is correlated with the hero image content description.

16. A computer-readable storage device configured with data and instructions which upon execution by a processor cause a computing system to perform a method for story message generation facilitation, the method comprising:
reading a candidate message;
ascertaining respective values of multiple suitability characteristics of the candidate message, the ascertaining comprising ascertaining at least one of the following candidate image suitability characteristics: a distance of the candidate image from a beginning of the message, whether the candidate image is a banner image, whether the candidate image is characterized as a tracking image, whether the candidate image has transparency, whether the candidate image is characterized as containing navigation text, whether the candidate image is characterized as containing a logo, a file format of the candidate image with a corresponding engagement statistic, whether the candidate image is characterized as containing primarily text, or whether the candidate image is identified in a metadata of the message as a proposed hero image;
submitting the at least one candidate image suitability characteristic value to a message hero image suitability scoring mechanism;
submitting at least one other suitability characteristic value of the candidate message to a different suitability scoring mechanism;
receiving from the message hero image suitability scoring mechanism a message hero image suitability score;
receiving from the different suitability scoring mechanism at least one of the following suitability scores: a message source suitability score, or a message story element suitability score; and
proceeding in a story message generation succession based on the suitability scores.

17. The computer-readable storage device of claim 16, wherein the method comprises: receiving three suitability scores, and proceeding in the story message generation succession based on the suitability scores.

18. The computer-readable storage device of claim 16, wherein the ascertaining comprises ascertaining values of N story message source suitability characteristics, where N is at least three but not more than ten.

19. The computer-readable storage device of claim 16, wherein the ascertaining comprises ascertaining values of N message hero image suitability characteristics, where N is at least five.

20. The computer-readable storage device of claim 16, wherein the ascertaining comprises ascertaining values of N story message story element suitability characteristics, where N is at least four but not more than eleven.
